(19) United States
(12) Patent Application Publication
(10) Pub. No.: US 2026/0205608 A1
(43) Pub. Date: Jul. 16, 2026

(54) INFORMATION PROCESSING DEVICE AND INFORMATION PROCESSING METHOD

(71) Applicant: JVCKENWOOD Corporation, Yokohama-shi (JP)

(72) Inventor: Hiroyuki Sato, Yokohama-shi (JP)

(21) Appl. No.: 19/560,222

(22) Filed: Mar. 9, 2026

Related U.S. Application Data
(63) Continuation of application No. PCT/JP2024/027638, filed on Aug. 2, 2024.

(30) Foreign Application Priority Data
Sep. 14, 2023 (JP) 2023-149421

(51) Int. Cl. H04N 19/172; H04N 19/115; H04N 19/167; H04N 19/63

(52) U.S. Cl. CPC H04N 19/172; H04N 19/115; H04N 19/167; H04N 19/63

(57) ABSTRACT

An information processing device includes: an image obtaining unit that obtains an image in which a photographic subject is captured; an image analyzing unit that analyzes the frequency components of the image and generates high-frequency component information indicating high-frequency components from among the frequency components; a distance information obtaining unit that obtains distance information related to the distance to the photographic subject; and a determining unit that, based on the distance information and the high-frequency component information, determines whether the photographic subject is planar or non-planar.

### CROSS-REFERENCE TO RELATED APPLICATIONS

This application is a Continuation of PCT International Application No. PCT/JP2024/027638 filed on August 2, 2024 which claims the benefit of priority from Japanese Patent Application No. 2023-149421, filed on September 14, 2023, the entire contents of both of which are incorporated herein by reference.

### BACKGROUND OF THE INVENTION

### 1. Field of the Invention

The application concerned is related to an information processing device and an information processing method.

### 2. Description of the Related Art

At the worksite of a civil engineering work, a construction equipment is remotely operated based on the images taken by a camera installed in the construction equipment. A construction equipment implies, for example, a mobile heavy equipment maneuvered by a person by getting into it. The taken images are then encoded and sent to the operator present at a remote location. As far as the video coding methods are concerned, methods such as H.264 and H.265 are known. Moreover, as far as the video coding technology is concerned, a technology is known in which, with respect to a region required to have texture reproducibility, the coding mode in which the maximum texture reproducibility is achieved is made selectable (for example, refer to Japanese Patent Application Laid-open No. 2008-219147).

However, there are times when the coding volume of the taken images increases and a high-bandwidth network becomes necessary in order to send the images to a remote location with minimal delay. For that reason, the remote operation of the construction equipment may get affected.

### SUMMARY OF THE INVENTION

It is an object of the present invention to at least partially solve the problems in the conventional technology.

The above and other objects, features, advantages and technical and industrial significance of this invention will be better understood by reading the following detailed description of presently preferred embodiments of the invention, when considered in connection with the accompanying drawings.

An information processing device according to the present disclosure comprising: an image obtaining unit that obtains an image in which a photographic subject is captured; an image analyzing unit that analyzes frequency components of the image and generates high-frequency component information indicating high-frequency components from among the frequency components; a distance information obtaining unit that obtains distance information related to distance to the photographic subject; and a determining unit that, based on the distance information and the high-frequency component information, determines whether the photographic subject is planar or non-planar.

An information processing method according to the present disclosure comprising: obtaining an image in which a photographic subject is captured; generating that includes analyzing frequency components of the image and generating high-frequency component information indicating high-frequency components from among the frequency components; obtaining distance information related to distance to the photographic subject; and determining, based on the distance information and the high-frequency component information, whether the photographic subject is planar or non-planar.

### BRIEF DESCRIPTION OF THE DRAWINGS

FIG. 1 is a diagram illustrating an exemplary configuration of a remote operation system according to an embodiment;

FIG. 2 is a block diagram illustrating an exemplary configuration of an information processing device according to the embodiment;

FIG. 3 is a diagram illustrating an exemplary method for encoding an image according to the embodiment;

FIG. 4 is a flowchart for explaining the details of the operations performed in the information processing device according to the embodiment;

FIG. 5 is flowchart for explaining the flow of a horizontal level determination operation for short distances according to the embodiment;

FIG. 6 is flowchart for explaining the flow of a horizontal level determination operation for intermediate distances according to the embodiment; and

FIG. 7 is flowchart for explaining the flow of a horizontal level determination operation for long distances according to the embodiment.

### DETAILED DESCRIPTION OF THE PREFERRED EMBODIMENTS

An exemplary embodiment of the application concerned is described below in detail with reference to the accompanying drawings. However, the application concerned is not limited by the embodiment described below. Moreover, in the embodiment, identical constituent elements are referred to by the same reference numerals, and their explanation is not given in a repeated manner.

### Embodiment

### Remote operation system

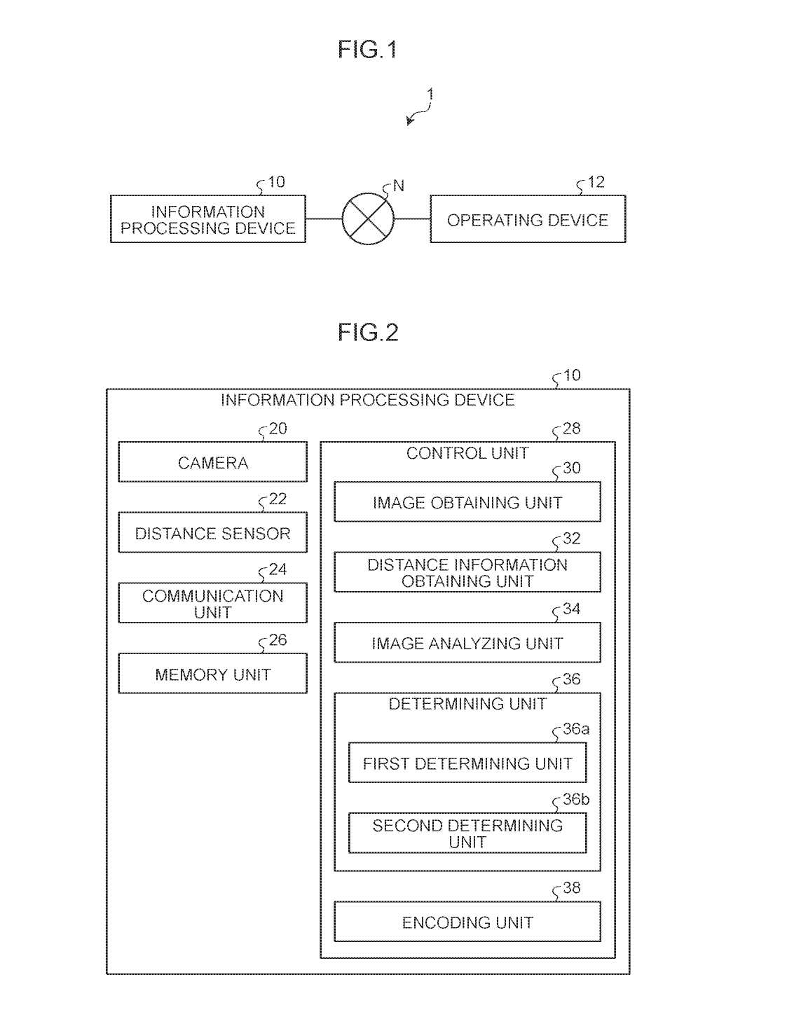

Explained below with reference to FIG. 1 is a remote operation system according to the embodiment. FIG. 1 is a diagram illustrating an exemplary configuration of the remote operation system according to the embodiment.

As illustrated in FIG. 1, the remote operation system 1 includes an information processing device 10 and an operating device 12. The information processing device 10 and the operating device 12 are communicably connected to each other via a network N.

The information processing device 10 is installed in a construction equipment that is assigned to a worksite. In the present embodiment, the construction equipment is not limited to a heavy equipment that can be moved around by a person by getting into it, and can alternatively be a fixed-type equipment that cannot be moved around. The construction equipment is used in, for example, embankment construction. The information processing device 10 sends, to the operating device 12, the images enabling achieving enhancement in the operational efficiency of the remote operation of the construction equipment. In the present embodiment, the images represent, for example, videos.

The operating device 12 is placed in an operation room present at a remote location with reference to the worksite. The operating device 12 includes a display unit for displaying the images of the worksite as taken by the information processing device 10. An operator operates the operating device 12 while checking the images of the worksite that are displayed in the display unit and accordingly performs remote operation of the construction equipment for carrying out the embankment construction.

### Information processing device

Explained below with reference to FIG. 2 is an exemplary configuration of the information processing device according to the embodiment. FIG. 2 is a block diagram illustrating an exemplary configuration of the information processing device according to the embodiment.

As illustrated in FIG. 2, the information processing device 10 includes a camera 20, a distance sensor 22, a communication unit 24, a memory unit 26, and a control unit 28.

The camera 20 takes images of the surrounding of the information processing device 10. Thus, the camera 20 takes images of the photographic subject that is present around the information processing device 10. For example, the camera 20 takes images of the condition of embankment going on around the information processing device 10. Then, the camera 20 outputs the taken images to an image obtaining unit 30.

The distance sensor 22 measures the distance from the information processing device 10 to the photographic subject. For example, the distance sensor 22 is a ToF sensor (ToF stands for Time of Flight). In that case, for example, the distance sensor 22 obtains a distance image in which the distance to the photographic subject is included. Alternatively, for example, the distance sensor 22 can be a LiDAR sensor (Light Detection and Ranging).

The communication unit 24 is a communication interface for enabling communication between the information processing device 10 and external devices. For example, the communication unit 24 performs communication between the information processing device 10 and the operating device 12. For example, the communication unit 24 is implemented using a wireless LAN (LAN stands for Local Area Network) or using Wi-Fi (registered trademark).

The memory unit 26 stores therein a variety of information. The memory unit 26 stores therein the details of arithmetic operations performed by the control unit 28, and stores therein information such as computer programs. The memory unit 26 includes, for example, at least either a main memory device such as a random access memory (RAM) or a read only memory (ROM), or an external storage device such as a hard disk drive (HDD).

The control unit 28 controls the constituent elements of the information processing device 10. For example, the control unit 28 includes an information processing device such as a central processing unit (CPU) or a micro processing unit (MPU), and includes a memory device such as a RAM or a ROM. The control unit 28 executes a computer program meant for controlling the operations of the information processing device 10 according to the present invention. Alternatively, for example, the control unit 28 can be implemented using an integrated circuit such as an application specific integrated circuit (ASIC) or a field programmable gate array (FPGA). Still alternatively, the control unit 28 can be implemented using a combination of hardware and software.

The control unit 28 includes the image obtaining unit 30, a distance information obtaining unit 32, an image analyzing unit 34, a determining unit 36, and an encoding unit 38.

The image obtaining unit 30 controls the camera 20 to take images. Then, the image obtaining unit 30 obtains the images taken by the camera 20. For example, the image obtaining unit 30 obtains the images of the photographic subject that are taken by the camera 20. Since the encoding unit 38 (disposed at a subsequent stage) processes signals not having the DC offset, the image obtaining unit 30 can remove the DC offset value.

The distance information obtaining unit 32 controls the distance sensor 22 to measure the distance from the information processing device 10 to the photographic subject. Then, the distance information obtaining unit 32 obtains, from the distance sensor 22, distance information indicating the distance from the information processing device 10 to the photographic subject.

The image analyzing unit 34 analyzes the images obtained by the image obtaining unit 30. For example, the image analyzing unit 34 performs frequency analysis with respect to the images obtained by the image obtaining unit 30. For example, the image analyzing unit 34 performs wavelet transform of the known type with respect to the images obtained by the image obtaining unit 30. For example, the image analyzing unit 34 performs wavelet transform with respect to the horizontal direction and the vertical direction of an image obtained by the image obtaining unit 30, and breaks down that image into the components of a plurality of frequency bands. For example, the image analyzing unit 34 breaks down the image, which is obtained by the image obtaining unit 30, into low-frequency components, mid-frequency components, and high-frequency components. Then, for example, regarding the image obtained by the image obtaining unit 30, the image analyzing unit 34 generates low-frequency component information indicating the low-frequency components, mid-frequency component information indicating the mid-frequency components, and high-frequency component information indicating the high-frequency components. For example, the image analyzing unit 34 generates at least the high-frequency component information indicating the high-frequency components of the image obtained by the image obtaining unit 30.

The determining unit 36 determines whether the photographic subject, which is captured in the image obtained by the image obtaining unit 30, is planar or non-planar. The determining unit 36 determines whether the embankment, which is captured in the image obtained by the image obtaining unit 30, is planar or non-planar. For example, based on the distance information obtained by the distance information obtaining unit 32 and based on the high-frequency component information generated by the image analyzing unit 34, the determining unit 36 determines whether the photographic subject, which is captured in the image obtained by the image obtaining unit 30, is planar or non-planar. For example, when wavelet transform is performed with respect to the horizontal direction of an image and when wavelet transform is also performed with respect to the vertical direction, the low-frequency components get concentrated in the top left direction of the output and the high-frequency components get concentrated in the bottom right direction of the output. Thus, depending on the quantity of the high-frequency components, the determining unit 36 determines whether the photographic subject is planar or non-planar. For example, the determining unit 36 divides the image, which is obtained by the image obtaining unit 30, into a plurality of regions, and determines whether each region is planar or non-planar.

The determining unit 36 includes a first determining unit 36a and a second determining unit 36b.

The first determining unit 36a determines the variation in the pixels of the distance image of the photographic subject as specified in the distance information obtained by the distance information obtaining unit 32. Then, based on variation in the pixels of the distance image, the first determining unit 36a determines whether the photographic subject is planar or non-planar.

The second determining unit 36b determines the signal level of the high-frequency components specified in the high-frequency component information generated by the image analyzing unit 34. Based on the signal level of the high-frequency components, the second determining unit 36b determines whether the photographic subject is planar or non-planar.

The determining unit 36 combines the determination results obtained by the first determining unit 36a and the second determining unit 36b, and accordingly determines whether the photographic subject is planar or non-planar. Herein, depending on the distance from the information processing device 10 to the photographic subject as specified in the distance information, the determining unit 36 expands the impact of the determination result from among the determination results obtained by the first determining unit 36a and the second determining unit 36b.

For example, when there is a long distance from the information processing device 10 to the photographic subject, the unevenness in the photographic subject is difficult to capture in an image, and consequently signals become unlikely to appear in the high-frequency components of the image. That is, the reliability of the distance information obtained by the distance information obtaining unit 32 becomes higher than the reliability of the analysis result obtained by the image analyzing unit 34 by performing frequency analysis. In that case, the determining unit 36 expands the impact of the determination result obtained by the first determining unit 36a. More particularly, even when the high-frequency components have a high signal level, if there is only small variation in the pixels of the distance image, the determining unit 36 determines that the photographic subject is planar.

For example, when there is a short distance from the information processing device 10 to the photographic subject, the unevenness in the photographic subject is easily captured in the image, and consequently signals appear easily in the high-frequency components of the image. That is, the reliability of the analysis result obtained by the image analyzing unit 34 by performing frequency analysis becomes higher than the reliability of the distance information obtained by the distance information obtaining unit 32. In that case, the determining unit 36 expands the impact of the determination result obtained by the second determining unit 36b. More particularly, even when there is large variation in the pixels of the distance image, if the high-frequency components have a low signal level, the determining unit 36 determines that the photographic subject is planar.

For example, when there is an intermediate distance from the information processing device 10 to the photographic subject, if the high-frequency components have a low signal level and if there is only small variation in the pixels of the distance image, the determining unit 36 determines that the photographic subject is planar.

Meanwhile, regarding the determination about whether there is a long distance from the information processing device 10 to the photographic subject, short, or intermediate, the corresponding threshold values can be set in advance.

The encoding unit 38 encodes the image obtained by the image obtaining unit 30. The encoding unit 38 performs encoding in such a way that there is low volume of information when the photographic subject that is captured in the image obtained by the image obtaining unit 30 is planar, and there is high volume of information when the photographic subject is non-planar. When the image obtained by the image obtaining unit 30 is divided into a plurality of regions, the encoding unit 38 performs encoding in such a way that there is high volume of information for the regions which are non-planar and there is low volume of information for the regions which are planar. The encoding unit 38 performs encoding in such a way that, in the image obtained by the image obtaining unit 30, the wavelet transform coefficients of the regions that are non-planar are bit-shifted toward the high-order bit side, and the bits resulting due to the bit shifting are padded with 0.

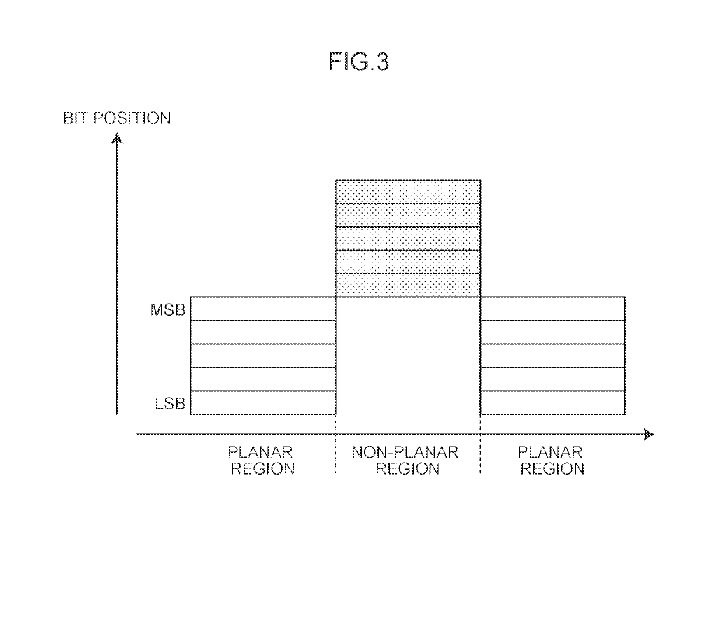

FIG. 3 is a diagram illustrating an exemplary method for encoding an image according to the embodiment. In FIG. 3, planar regions and non-planar regions are arranged along the horizontal axis, and the vertical axis indicates the bit positions. In FIG. 3 is schematically illustrated the condition in which the wavelet transform coefficients of the planar regions and the non-planar regions, which are included in the image obtained by the image obtaining unit 30, are expanded in a bit plane. The most significant bit (MSB) represents the highest-order bit of the planar regions. The least significant bit (LSB) represents the lowest-order bit of the non-planar regions. As illustrated in FIG. 3, the encoding unit 38 encodes the image, which is obtained by the image obtaining unit 30, by performing bit shifting of the wavelet transform coefficients of the non-planar regions to a higher order than the most significant bit of the planar regions. Thus, the encoding unit 38 can prevent a situation in which the non-planar regions are encoded with priority from the high-order bits, thereby resulting in the deterioration of the image quality of the non-planar regions.

### Details of operations

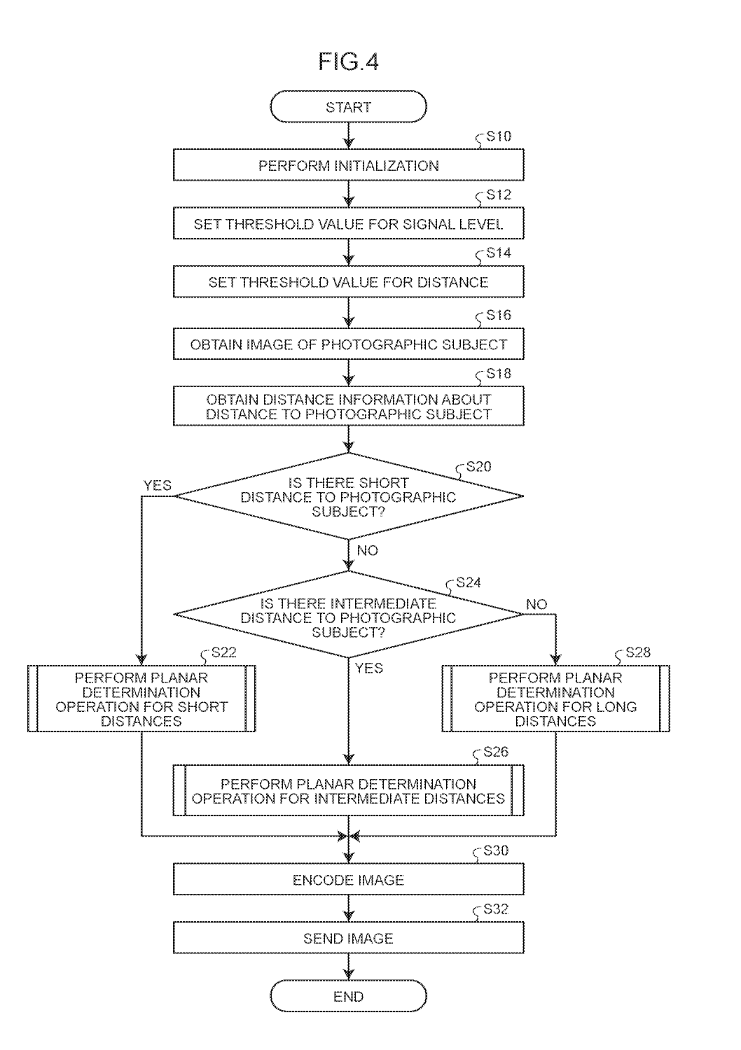

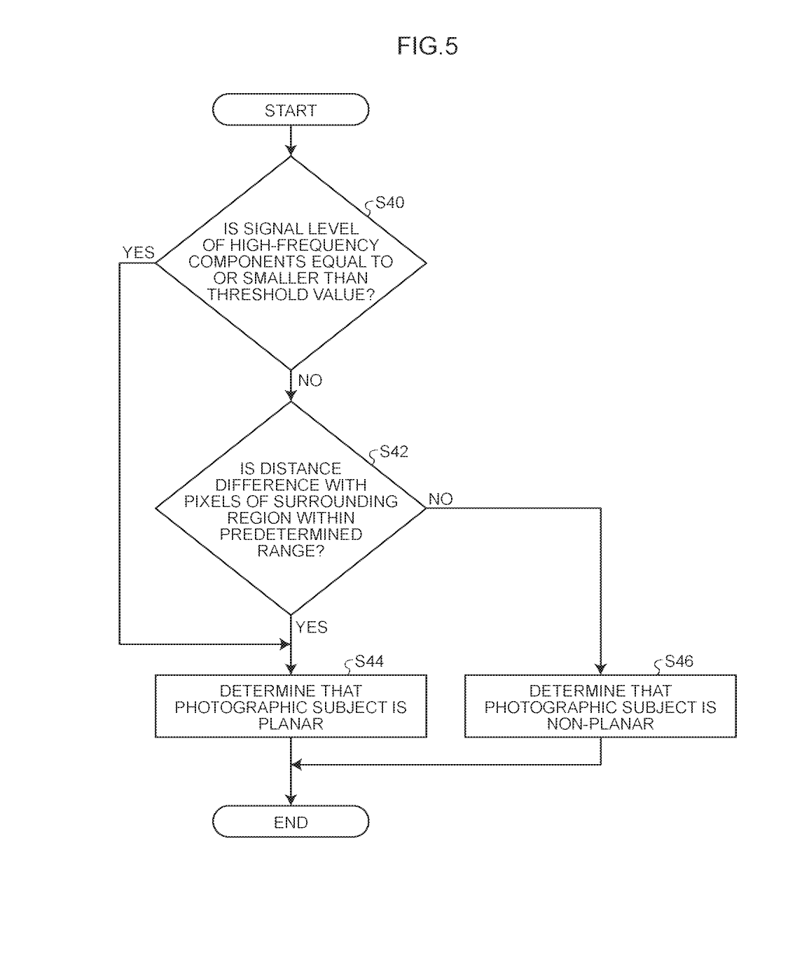

Explained below with reference to FIG. 4 are the details of the operations performed in the information processing device according to the embodiment. FIG. 4 is a flowchart for explaining the details of the operations performed in the information processing device according to the embodiment.

The control unit 28 performs initialization before starting the operations (Step S10). Then, the system control proceeds to Step S12.

The control unit 28 sets a threshold value for the signal level (Step S12). More particularly, the control unit 28 sets the threshold value for the signal level of the high-frequency components in the image that are to be used in determining whether the photographic subject is planar or non-planar. Then, the system control proceeds to Step S14.

The control unit 28 sets a threshold value for the distance (Step S14). More particularly, the control unit 28 sets the threshold value for the distance from the information processing device 10 to the photographic subject, with that distance being meant for use in determining whether the photographic subject is planar or non-planar. Then, the system control proceeds to Step S16.

The image obtaining unit 30 obtains, from the camera 20, an image in which the photographic subject is captured (Step S16). More particularly, the image obtaining unit 30 controls the camera 20 to take an image of the photographic subject, and obtains the image taken by the camera 20. Then, the system control proceeds to Step S18.

The distance information obtaining unit 32 obtains, from the distance sensor 22, the distance information indicating the distance from the information processing device 10 to the photographic subject (Step S18). More particularly, the distance information obtaining unit 32 controls the distance sensor 22 to detect the distance from the information processing device 10 to the photographic subject and obtains the distance information indicating the distance detected by the distance sensor 22. Then, the system control proceeds to Step S20.

The distance information obtaining unit 32 determines whether there is a short distance from the information processing device 10 to the photographic subject (Step S20). When it is determined that there is a short distance from the information processing device 10 to the photographic subject (Step S20). When it is determined that there is a short distance from the information processing device 10 to the photographic subject (Yes at Step S20), the system control proceeds to Step S22. When it is not determined that there is a short distance from the information processing device 10 to the photographic subject (No at Step S20), the system control proceeds to Step S24.

When the determination is yes at Step S20, the determining unit 36 performs a horizontal level determination operation for short distances (Step S22). The flow of the horizontal level determination operation for short distances according to the embodiment is explained with reference to FIG. 5.

The second determining unit 36b determines whether the high-frequency components of the image of the photographic subject have the signal level equal to or smaller than the threshold value (Step S40). When it is determined that the high-frequency components of the image of the photographic subject have the signal level equal to or smaller than the threshold value (Yes at Step S40), the system control proceeds to Step S44. When it is not determined that the high-frequency components of the image of the photographic subject have the signal level equal to or smaller than the threshold value (No at Step S40), the system control proceeds to Step S42.

When the determination at Step S40 is no, the first determining unit 36a determines whether or not the pixels in a region of interest in the distance image and the pixels in the surrounding region of the region of interest have the distance difference within a predetermined range (Step S42). A region of interest represents a region that includes one or more pixels corresponding to the photographic subject in the distance image. A region of interest includes, for example four pixels in a 2×2 matrix. Meanwhile, it is possible to set either a plurality of regions of interest or only a single region of interest corresponding to the photographic subject. Moreover, the predetermined range can be set in an arbitrary manner. When it is determined that the pixels in a region of interest and the pixels in the surrounding region of the region of interest have the distance difference within a predetermined range (Yes at Step S42), the system control proceeds to Step S44. When it is not determined that the pixels in a region of interest and the pixels in the surrounding region of the region of interest have the distance difference within a predetermined range (No at Step S42), the system control proceeds to Step S46.

When the determination at Step S40 is yes or when the determination at Step S42 is yes, the determining unit 36 determines that the photographic subject is planar (Step S44). That marks the end of the operations illustrated in FIG. 5, and the system control proceeds to Step S30 illustrated in FIG. 4.

When the determination at Step S42 is no, the determining unit 36 determines that the photographic subject is non-planar (Step S46). That marks the end of the operations illustrated in FIG. 5, and the system control proceeds to Step S30 illustrated in FIG. 4.

Returning to the explanation with reference to FIG. 4, when the determination at Step S20 is no, the distance information obtaining unit 32 determines whether or not there is an intermediate distance from the information processing device 10 to the photographic subject (Step S24). When it is determined that there is an intermediate distance from the information processing device 10 to the photographic subject (Yes at Step S24), the system control proceeds to Step S26. When it is not determined that there is an intermediate distance from the information processing device 10 to the photographic subject (No at Step S24), the system control proceeds to Step S28.

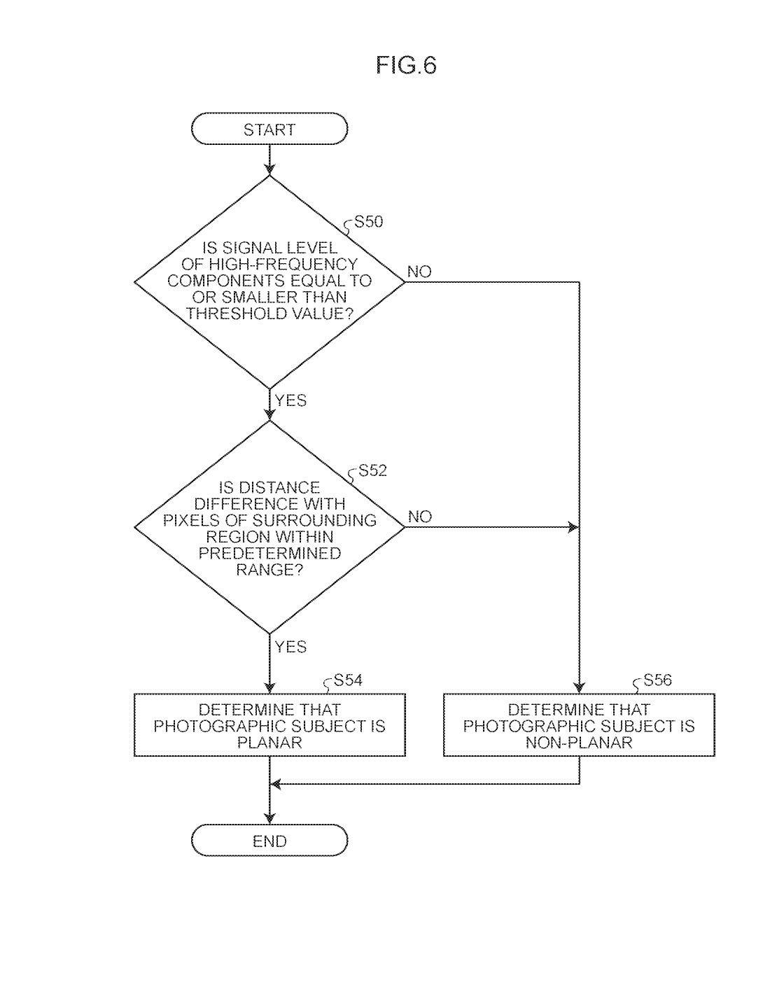

When the determination at Step S24 is yes, the determining unit 36 performs a horizontal level determination operation for intermediate distances (Step S26). The flow of the horizontal level determination operation for intermediate distances according to the embodiment is explained with reference to FIG. 6.

The second determining unit 36b determines whether or not the high-frequency components of the image of the photographic subject have the signal level equal to or smaller than the threshold value (Step S50). When it is determined that the high-frequency components of the image of the photographic subject have the signal level equal to or smaller than the threshold value (Yes at Step S50), the system control proceeds to Step S52. When it is not determined that the high-frequency components of the image of the photographic subject have the signal level equal to or smaller than the threshold value (No at Step S50), the system control proceeds to Step S56.

When the determination at Step S50 is yes, the first determining unit 36a determines whether or not the pixels in a region of interest in the distance image and the pixels in the surrounding region of the region of interest have the distance difference within a predetermined range (Step S52). When it is determined that the pixels in a region of interest and the pixels in the surrounding region of the region of interest have the distance difference within a predetermined range (Yes at Step S52), the system control proceeds to Step S54. When it is not determined that the pixels in a region of interest and the pixels in the surrounding region of the region of interest have the distance difference within a predetermined range (Yes at Step S52), the system control proceeds to Step S56.

When the determination at Step S52 is yes, the determining unit 36 determines that the photographic subject is planar (Step S54). That marks the end of the operations illustrated in FIG. 6, and the system control proceeds to Step S30 illustrated in FIG. 4.

When the determination at Step S50 is no or when the determination at Step S52 is no, the determining unit 36 determines that the photographic subject is non-planar (Step S56). That marks the end of the operations illustrated in FIG. 6, and the system control proceeds to Step S30 illustrated in FIG. 4.

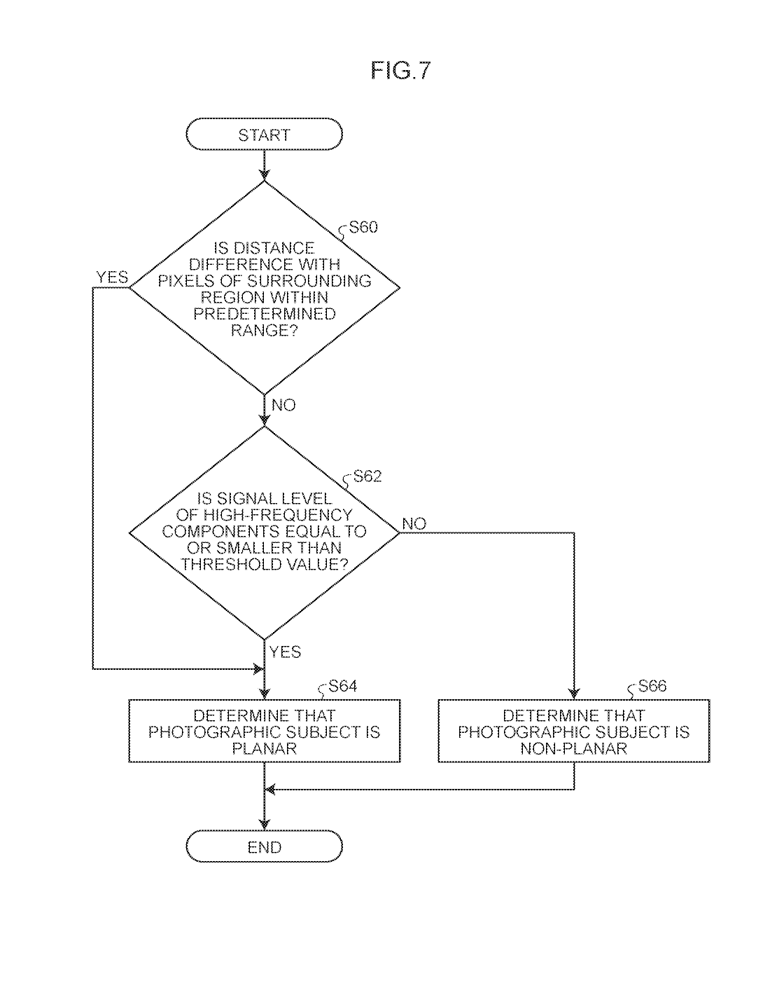

Returning to the explanation with reference to FIG. 4, when the determination at Step S24 is no, the determining unit 36 performs a planarity determination operation for long distances (Step S28). The flow of the horizontal level determination operation for long distances according to the embodiment is explained with reference to FIG. 7.

The first determining unit 36a determines whether or not the pixels in a region of interest in the distance image and the pixels in the surrounding region of the region of interest have the distance difference within a predetermined range (Step S60). When it is determined that the pixels in a region of interest and the pixels in the surrounding region of the region of interest have the distance difference within a predetermined range (Yes at Step S60), the system control proceeds to Step S64. When it is not determined that the pixels in a region of interest and the pixels in the surrounding region of the region of interest have the distance difference within a predetermined range (No at Step S60), the system control proceeds to Step S62.

When the determination at Step S60 is no, the second determining unit 36b determines whether the high-frequency components of the image of the photographic subject have the signal level equal to or smaller than the threshold value (Step S62). When it is determined that the high-frequency components of the image of the photographic subject have the signal level equal to or smaller than the threshold value (Yes at Step S62), the system control proceeds to Step S64. When it is not determined that the high-frequency components of the image of the photographic subject have the signal level equal to or smaller than the threshold value (No at Step S62), the system control proceeds to Step S66.

When the determination at Step S60 is yes or when the determination at Step S62 is yes, the determining unit 36 determines that the photographic subject is planar (Step S64). Then, the system control proceeds to Step S30 illustrated in FIG. 4.

When the determination at Step S62 is no, the determining unit 36 determines that the photographic subject is non-planar (Step S66). Then, the system control proceeds to Step S30 illustrated in FIG. 4.

The encoding unit 38 encodes the image obtained by the image obtaining unit 30 (Step S30). More particularly, based on the determination result obtained by the determining unit 36, the encoding unit 38 performs encoding in such a way that there is low volume of information for the regions which are planar and there is high volume of information for the regions which are non-planar. Then, the system control proceeds to Step S32.

The encoding unit 38 sends the encoded image to the operating device 12 via the communication unit 24 (Step S32). That marks the end of the operations illustrated in FIG. 4.

As explained above, in the embodiment, at a worksite, images are encoded in such a way that there is low volume of information for the regions which are planar due to completion of the work and there is high volume of information for the regions which are non-planar because of the unfinished work; and then the encoded images are sent to the operating device 12 that is present at a remote location and that operated by an operator of a heavy equipment. As a result, in the present embodiment, the operator becomes able to operate the heavy equipment based on clear images of the worksite. That enables achieving enhancement in the operational efficiency.

The constituent elements of the device illustrated in the drawings are merely conceptual, and need not be physically configured as illustrated. The constituent elements, as a whole or in part, can be separated or integrated either functionally or physically based on various types of loads or use conditions. Moreover, a configuration based on such separation/integration can be achieved in a dynamic manner.

According to the application concerned, it becomes possible to enhance the operational efficiency of the remote operation of a construction equipment.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An information processing device comprising:
an image obtaining unit that obtains an image in which a photographic subject is captured;
an image analyzing unit that analyzes frequency components of the image and generates high-frequency component information indicating high-frequency components from among the frequency components;
a distance information obtaining unit that obtains distance information related to distance to the photographic subject; and
a determining unit that, based on the distance information and the high-frequency component information, determines whether the photographic subject is planar or non-planar.

2. The information processing device according to claim 1, wherein
the determining unit includes
a first determining unit that, based on variation in distance indicated by each pixel in a distance image of the photographic subject as specified in the distance information, determines whether the photographic subject is planar or non-planar, and
a second determining unit that, based on signal level of the high-frequency components specified in the high-frequency component information, determines whether the photographic subject is planar or non-planar, and
the determining unit combines determination results, which are obtained by the first determining unit and the second determining unit, according to distance to the photographic subject as specified in the distance information, and accordingly determines whether the photographic subject is planar or non-planar.

3. The information processing device according to claim 2, wherein
when pixels in a region of interest in the photographic subject in the distance image and pixels in surrounding region of the region of interest have distance difference within a predetermined range, the first determining unit determines that the photographic subject is planar, and
when the high-frequency components specified in the high-frequency component information have signal level equal to or smaller than a threshold value, the second determining unit determines that the photographic subject is planar.

4. The information processing device according to claim 2, wherein
when distance to the photographic subject is long, the determining unit proportionally expands the determination result obtained by the first determining unit, and
when distance to the photographic subject is short, the determining unit proportionally expands the determination result obtained by the second determining unit.

5. The information processing device according to claim 1, further comprising an encoding unit that encodes the image, wherein
regarding each of a plurality of regions of the image, the determining unit determines whether the region is planar or non-planar, and
the encoding unit encodes the image in such a way that there is high volume of information for a region that is non-planar from among the plurality of regions, and there is low volume of information for a region that is planar from among the plurality of regions.

6. The information processing device according to claim 4, further comprising an encoding unit that encodes the image, wherein
regarding each of a plurality of regions of the image, the determining unit determines whether the region is planar or non-planar, and
the encoding unit encodes the image in such a way that there is high volume of information for a region that is non-planar from among the plurality of regions, and there is low volume of information for a region that is planar from among the plurality of regions.

7. The information processing device according to claim 5, wherein
the image analyzing unit performs wavelet transform with respect to the image, and
regarding wavelet transform coefficient of a region that is non-planar, the encoding unit performs bit shifting toward high-order bit side, and then encodes the image.

8. The information processing device according to claim 6, wherein
the image analyzing unit performs wavelet transform with respect to the image, and
regarding wavelet transform coefficient of a region that is non-planar, the encoding unit performs bit shifting toward high-order bit side, and then encodes the image.

9. An information processing method comprising:
obtaining an image in which a photographic subject is captured;
generating that includes analyzing frequency components of the image and generating high-frequency component information indicating high-frequency components from among the frequency components;
obtaining distance information related to distance to the photographic subject; and
determining, based on the distance information and the high-frequency component information, whether the photographic subject is planar or non-planar.
